(19) United States
(12) Patent Application Publication
(10) Pub. No.: US 2012/0158264 A1
(43) Pub. Date: Jun. 21, 2012

(54) Clutch calibration for continuously variable transmission

(75) Inventors: Brian D. Kuras, East Peoria, IL (US); Michael J. Barngrover, Peoria, IL (US); Brian E. Lister, Edwards, IL (US); Michael Beyer, Chillicothe, IL (US); Ligang Zhang, (US)

(73) Assignee: CATERPILLAR INC., Peoria, IL (US)

(21) Appl. No.: 12/974,666

(22) Filed: Dec. 21, 2010

(51) Int. Cl. F16D 48/06

(52) U.S. Cl. 701/67

(57) ABSTRACT

A calibration system for calibrating a transmission provides a calibrated clutch fill time for an oncoming clutch by activating a parking brake of a machine associated with the transmission and calibrating each clutch by setting a transmission characteristic parameter to an initial value, and then activating a clutch solenoid associated with the clutch. The transmission characteristic is periodically measured, and when the measured value of the transmission characteristic exceeds the initial value for a predetermined number of consecutive periods, the fill time for the clutch is set equal to the time elapsed during the total number of measurement periods minus one less than the predetermined number of consecutive periods.

### TECHNICAL FIELD

The present disclosure relates generally to systems and methods for calibrating a hydraulic transmission and, more particularly, to systems and methods for calibrating a flow of a pressurized operating medium within a clutch-controlled transmission.

### BACKGROUND

Fluid-operated clutches (e.g., clutches operated by hydraulic or synthetic oil or other pressurized fluid) are generally well known and can be found in many systems and devices. Such clutches are hereinafter referred to as “hydraulic clutches.” One primary use for the hydraulic clutch is to provide shifting between differing input/output gear ratios within a power transmission such as a continuously variable transmission. Typically, such a transmission includes two input shafts and an output shaft, as well as one or more trains of interrelated gear elements usable to selectively couple the input and output shafts. The selection of a gear ratio at the output shaft is executed via one or more clutches that affect the rotations and/or interrelationships of the gear elements. The clutches are typically hydraulically driven to engage band or disk torque transfer elements.

Shifting from one gear ratio to another normally involves releasing or disengaging an off-going clutch or clutches associated with the current gear ratio and applying or engaging an oncoming clutch or clutches associated with the desired gear ratio. Each hydraulic clutch is typically controlled via an electrically controlled solenoid valve. The solenoid valves are electrically modulated to control hydraulic fluid pressure to the clutch and hence to control the clutch movement (e.g., in the absence of contact) and pressure (e.g., during contact).

In general terms, the clutches within a transmission are controlled both with respect to the engagement force of individual clutches as well as the timing or phase between clutch activation, e.g., between dropping an off-going clutch and activating an oncoming clutch. The force and phase with which the transmission clutches are manipulated greatly impact the resulting shift quality. For example, if the off-going clutch disengages prematurely, the engine speed may surge momentarily before the oncoming clutch begins torque transfer, resulting in a rough shift. Similarly, if the oncoming clutch engages prematurely, a suboptimal shift can result. In addition to creating an unpleasant user experience, poorly calibrated shifting can also impact the efficiency and service life of the transmission. To this end, it is desirable to calibrate the clutches of a hydraulic transmission.

Complicating this issue, a CVT performing synchronous shifts as quickly as possible must find the fill time of a clutch when the clutch valve is fully actuated (i.e., fully open). Unlike a powershift wherein there is sufficiently low torque capacity as to still allow clutch slip at the end of its clutch fill, the clutch in a CVT fill is at a high enough torque capacity to drive through the park brake, resulting in unintended motion.

Accordingly, there is a need for a transmission clutch control system that provides effective, convenient, and unobtrusive calibration of a CVT system, without requiring the addition of expensive dedicated equipment, in order to generally enhance transmission usability and longevity.

### BRIEF SUMMARY

This disclosure describes, in one aspect, a method of calibrating a-continuously variable transmission that is driven by an engine and a secondary power source, and having first and second input shafts and an output shaft. It will be appreciated that the secondary power source is a secondary device for providing power, but that it may derive its energy from the engine output, e.g., via a hydraulic pump, electrical generator, etc. Thus, the secondary power source will generally not increase the overall power of the system.

The transmission includes multiple clutches, with each clutch being operable to select one of a number of selectable ranges of the transmission. The clutch controller receives a request to calibrate and prepares the transmission for clutch calibration by commanding a set variable member speed, applying a torque limit to the speed control, placing the transmission in neutral, and assuring engagement of a parking brake associated with the machine. Moreover, in a multiple clutch per range configuration, all clutches for a range are engaged at this point except the clutch being calibrated. After such preparation, the controller executes a calibration routine for each clutch to identify a fill time for the clutch.

In another aspect, a machine is provided having a self-calibrating transmission system. The machine includes an engine, a parallel path variable transmission having first and second inputs and an output, with the first input linked to the engine and the second input linked to a secondary power source. The continuously variable transmission includes a plurality of hydraulic clutches operable to select a range of the transmission when actuated. A controller is configured to prepare the transmission for clutch calibration by commanding a set variable member speed, applying a torque limit to the speed control, and assure engagement of a parking brake associated with the machine, and to calibrate each clutch to identify a fill time for the clutch.

In yet another aspect, a method of calibrating such a clutch within a transmission having a plurality of such clutches is provided. The method entails activating a parking brake of a machine associated with the transmission and calibrating each clutch by setting a transmission characteristic parameter to an initial value, and then activating a clutch solenoid associated with the clutch.

The transmission characteristic is periodically measured; when the measured value of the transmission characteristic exceeds the initial value for a predetermined number of consecutive periods, the fill time for the clutch is equal to the time elapsed during the total number of measurement periods minus one less than the predetermined number of consecutive periods.

### BRIEF DESCRIPTION OF THE DRAWINGS

FIG. 1 is a schematic view of a machine transmission system including a machine power train, transmission, and related control system;

FIG. 2 is a schematic diagram of control elements in an embodiment, showing the control and data flow within the clutch and clutch control system;

FIG. 3 is a flow chart illustrating a process flow for executing a generalized clutch calibration process according to an exemplary implementation of the described principles;

FIG. 4 is a flow chart illustrating a calibration process in accordance with an implementation wherein end of fill is detected based on detecting a predetermined extent of speed variance from a speed command;

FIG. 5 is a flow chart illustrating a calibration process in accordance with an implementation wherein the end of fill is detected based on detecting a predetermined level of loop pressure increase within the variator; and

FIG. 6 is a flow chart illustrating a calibration process in accordance with an implementation wherein the end of fill time is detected based on detecting a PID torque command variance of a certain extent.

### DETAILED DESCRIPTION

The disclosure relates to a system and method for the calibration of hydraulic clutches within a hydraulic transmission. In particular, to improve shift robustness for a continuously variable transmission, a clutch fill calibration system and method are provided to determine fill time for one or more clutches.

Prior to discussing implementations in detail, a brief overview of principles is given to aid the reader. In general terms, three phases of interest in the described system include the execution of fill attempts, an end of fill detection scheme, and a calibration success detection mechanism. In an embodiment, because of the sizable torque capacity at the end of fill, the CVT is calibrated in a state such that when the clutch is engaged, the resultant output speed will be zero. However, a CVT clutch fill performed in this state will have no typical detectable end of fill characteristic. In order to overcome this issue, the CVT is placed in a state (via setting the variable member speed) that will result in very small transmission output speed if the clutch were engaged. But because the park brake is also applied, this creates a tension where the output shaft is required to be at two distinct speeds, i.e., zero and not zero. This difference is reconciled internally in the transmission by a rise in variator torque. It is this rise in variator torque (a processed loop pressure signal) that is then used to detect an end of fill event.

Without sufficient response time to turn off the clutch, the rise in variator torque could lead to unintended machine movement as the transmission drives through the park brake. Thus, in an embodiment, the system attempts clutch fills at predetermined limited pulse durations, rather than turning on the clutch fully. In this manner, the clutch fill is “crept up to” from a minimal value, and minimizes the amount of variator torque rise, because the clutch valve is already in an electrically “off” state before end of fill happens.

With respect to end of fill detection, this may be detected via a change in speed, a change in pressure (torque), and/or a change in a PID control parameter. It is not critical to use actual loop pressure, and in various embodiments, derivative values and/or ratios thereof may be used. Moreover, for non-hydraulic variators, another analogous measure such as a torque value may be used.

With respect to identifying calibration success, a histogram or other record is maintained in memory, and the system determines the fill time based on a degree, number, or percentage of successful fills at a given pulse duration. Different levels of engagement and repeatability values may be accounted for, e.g., a single very successful pulse duration, two nearly equally successful pulse durations (if an actual fill time is a fractional loop) may be treated equally. In other words, a single duration that is very successful, but that has not reach a single success threshold yet because of a few outlier results may be credited as a success regardless.

Turning to a hydraulic clutch system by way of example only, a hydraulic clutch actuator typically comprises a movable element, e.g., a piston within a chamber. The movable element will typically need to move a finite distance prior to causing initial contact between two torque transfer surfaces or elements. For a fluid clutch, the period during which pressurized fluid is introduced into the chamber to cause such movement is generally referred to as the clutch fill period or fill time. This period is controlled electronically via the application of a pulse signal to a solenoid valve associated with the clutch chamber.

Calibration of the pulse width value, or fill time, allows for smoother shifts. This not only provides an improved operator experience, but also potentially improves transmission life by minimizing drive train shock due to overly short shifts as well as heat generation due to overly long shifts.

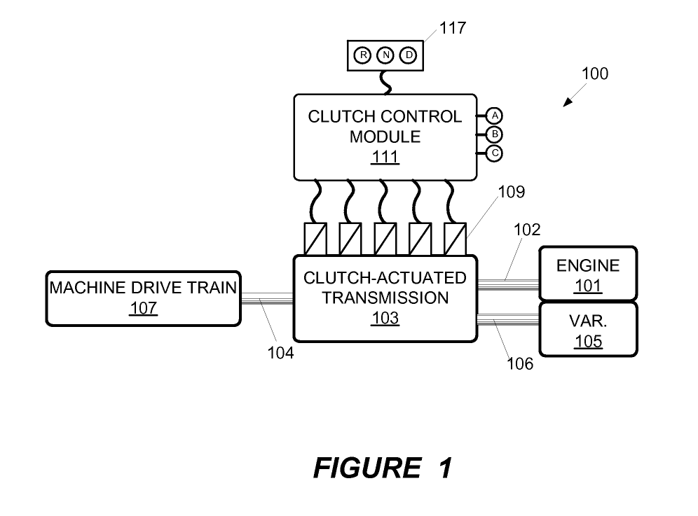

Referring now to the drawings, FIG. 1 schematically illustrates a transmission system 100 including a machine power train and related control system. The power train comprises a prime mover, such as an internal combustion engine 101, coupled to an input 102 of a transmission 103. The output 104 of the transmission 103 is in turn linked to a machine drive train 107, e.g., to drive one or more axles or tracks for movement of the machine. A parallel input 106 to the transmission 103 receives power from a variator 105 or other rotational power source. In operation, variation of the variator 105 speed allows a step-less variation of the transmission 103 output speed.

The examples herein generally assume a fluid clutch environment, but it will be appreciated that the described principles also apply to other clutch types. For example, clutch actuation may be non-hydraulic (e.g., via electrical rotary cam) and the method of determining the lag between the request for clutch actuation, to the point that the torque elements are capable of transferring torque is still applicable.

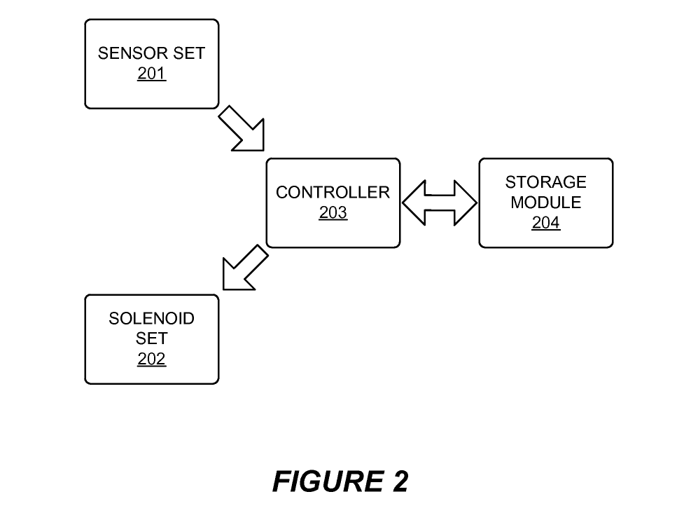

In the illustrated example, the transmission 103 comprises a plurality of clutches (shown in greater detail in FIG. 2) associated with gear elements or gear element sets within the transmission 103 to execute range shifts. Each of the plurality of clutches comprises a positive displacement cylinder and piston arrangement. In a fluid clutch system, the clutches are controlled by a series of dedicated solenoid valves 109, sometimes referred to as “electro-hydraulic” valves. In the illustrated embodiment, each solenoid valve 109 responds to an applied current level to supply hydraulic fluid to the associated clutch at a pressure correlated to the applied current. The resulting pressure may also be limited by the supply pressure and by any flow limitations, such as those caused by an orifice in the flow path.

The solenoid valves are in turn controlled by an electronic clutch control module 111. In particular, the electronic clutch control module 111 selectively applies current signals to the solenoid valves 109 to selectively engage and disengage various clutches to execute a desired shift. In addition to certain shifts that may take place automatically, the control module 111 also receives input from a user-actuated shift selector 117 in one example. For example, the operator can use the selector 117 to select a forward, reverse, or neutral state.

The timing of an automatic shift operation depends largely on the rotational speeds of the input 102, 106 and output 104 shafts of the transmission 103. To this end, speed sensors may be located adjacent shafts 102, 106 and 104 respectively, and their respective outputs A, B are linked to the electronic clutch control module 111.

The shift timing and execution are also affected by other factors such as speed control position (e.g., accelerator pedal position) and transmission oil temperature. Thus, the electronic clutch control module 111 also receives inputs from a speed control position sensor (not shown) and a transmission oil temperature sensor (not shown), as well as other machine-related sensors such as circuit and actuator pressure sensors. The sensors described herein may be conventional sensors such as potentiometers, thermistors, optical or magnetic speed pickups, and so on.

The electronic clutch control module 111 comprises a computing device such as a microprocessor, programmable logic array (PLA) or programmable logic controller (PLC) (hereinafter, collectively “processor”). Either as part of the computing device or in association with it, the electronic clutch control module 111 also comprises clocking facilities, data inputs, memory, control outputs, and current drivers associated with the control outputs for driving the solenoids 109. It will be appreciated that the processor of the electronic clutch control module 111 operates via execution of computer-readable instructions, e.g., software, stored on a computer-readable medium such as an electrical, magnetic, or optical medium.

Typically, each solenoid valve 109 responds proportionally to an applied current. As such, in one example, the control outputs of the current drivers are digital pulse width modulated (PWM) signals representing on average a desired current signal. This allows the electronic clutch control module 111 to control the clutch pressure in a proportional manner via appropriate command signals to the solenoid drivers.

In operational overview with respect to the illustration of FIG. 1, the electronic clutch control module 111 monitors the input and output shaft speeds and circuit and other pressures associated with the transmission 103 via the appropriate sensors. When the input shaft speed exceeds a higher threshold (or falls below a lower threshold), and/or when an operator shift request is received, the electronic clutch control module 111 responsively controls the solenoid valves 109 to execute an up-shift or a downshift as appropriate. The higher and lower thresholds may be predetermined, but need not be in every case.

The transmission 103 may be shifted between adjacent ranges by releasing one or more off-going clutches and engaging one or more oncoming clutches. Thus, during any given shift, most of the solenoid valves 109 will remain inactive (i.e., not providing a flow of pressurized fluid to the associated chamber), with their associated clutches thus disengaged. In an example, there are five clutches in transmission 103 that are used for shifting. However, a greater or lesser number of clutches may be used depending upon the intended application and designer preferences.

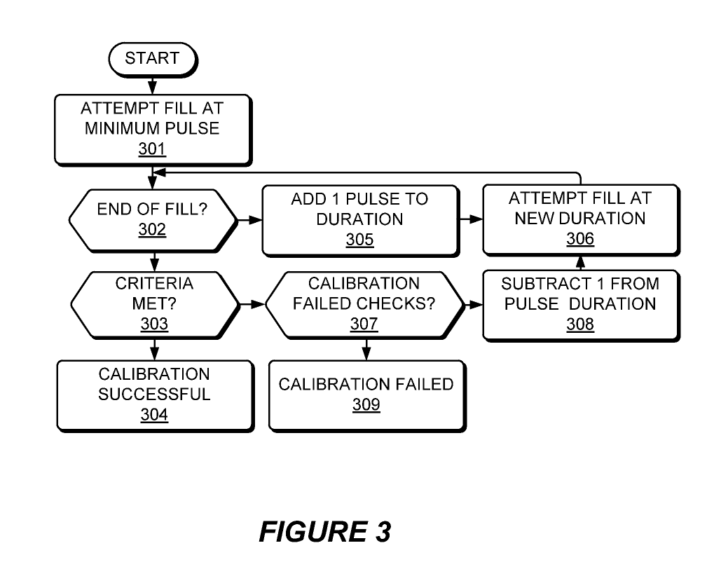

For the further understanding of the reader, FIG. 2 illustrates a schematic of control elements showing the control and data flow within the clutch and clutch control system in an embodiment. The illustrated system 200 includes a sensor set 201, and solenoid set 202, and a controller 203 (e.g., in the form of or within clutch control module 111 and/or an ECM, and/or other controlling module or device). The controller 203 physically receives electronic data signals from the sensor set 201, performs computations to effect the calibration technique described hereinafter with reference to FIGS. 3-6, and outputs electronic control signals to the solenoid set during calibration, and potentially during clutch operation after calibrations as well. A storage module 204 associated with the controller 203 is used by the controller 203 to store calibration values and to later retrieve such values when needed during clutch operation.

As noted above, the sensors of the sensor set 201 may include sensors for engine, output and variator speeds, clutch actuator and variator circuit pressures, engine and transmission temperatures, fluid temperatures, transmission shift selector position, machine movement, and so on. The solenoid set 202 includes primarily the clutch actuation solenoids.

Thus, in an embodiment, sensor data flows from the sensor set 201 to the controller 203, while control signals flow from the controller 203 to the solenoid set 201 during calibration and operation. Calibration data signals travel bi-directionally between the controller 203 and the storage module 204 for storage and retrieval.

A generalized calibration process 300 is shown by way of the flowchart of FIG. 3. At stage 301 of the process 300, the system attempts a clutch fill at a minimum pulse duration. If the fill is successful, as determined at stage 302, then the process 300 flows to stage 303, wherein it is determined whether the calibration criteria have been met. If so, the calibration is deemed successful and the process 300 terminates at stage 304.

If instead it is determined at stage 302 that end of fill was not reached, then the process 300 flows to stage 305 and the attempt duration is extended by 1, and a new fill attempt is made at stage 306. At this point, the process 300 returns to stage 302 to evaluate end of fill.

Returning to stage 303, if it is determined at this stage that the calibration criteria have not been met, then the process 300 flows to stage 307 to determine if the calibration has failed any checks. If not, the process 300 flows from stage 307 to stage 308, where the pulse duration is decremented by 1, and another fill is attempted at stage 309. If instead it is determined at stage 307 that the calibration has failed one or more checks, the process 300 terminates at stage 309, with the calibration deemed failed.

As noted above the calibration procedure may be executed in a number of ways depending upon user needs and implementation. Exemplary techniques for detecting end of fill within these include (1) in a CVT, detecting a predetermined extent of variable member speed variance from variable member speed command, (2) in a hydraulic variator, detecting a predetermined level of loop pressure increase within the variator (for example, but not limited to, an increase in Loop Pressure(t)/(Loop Pressure(t−2)), and (3) detecting a PID torque command variance of a certain extent.

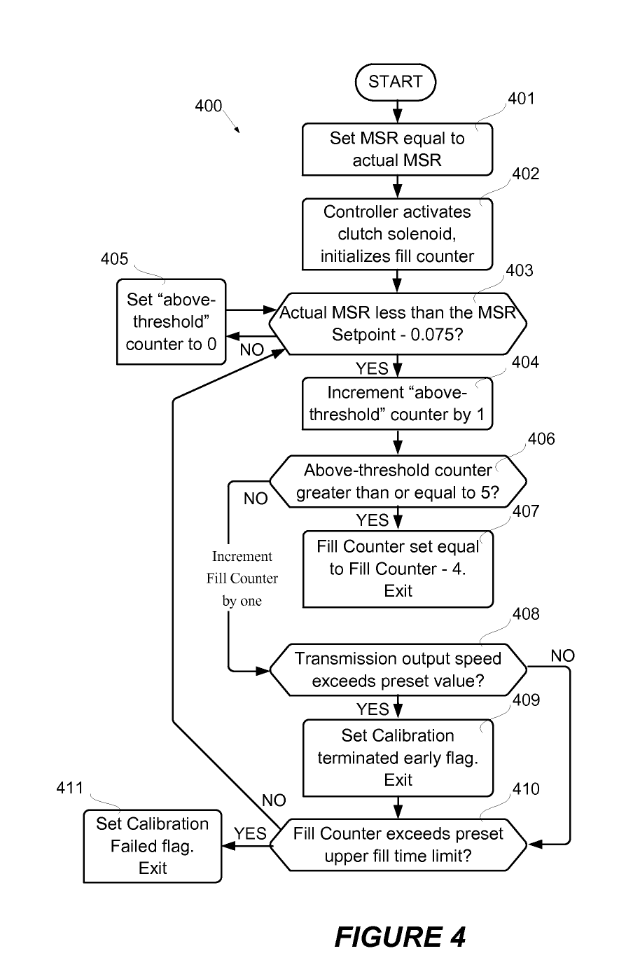

Referring to FIG. 4, a calibration process 400 is shown in accordance with one possible implementation, wherein end of fill is detected based on detecting a predetermined extent of variable member speed variance from variable member speed command. The process 400 begins at stage 401 when the variable member speed setpoint is equal to the actual variable member speed (averaged, e.g., over 20 loops). At stage 402, the controller activates the clutch solenoid with a first pulse value and sets a fill counter to an initial value of 0. At stage 403, the controller determines whether the actual variable member speed is more than 0.075 less than the variable member speed Setpoint. If the actual current variable member speed is more than 0.075 less than the variable member speed Setpoint, then an “above-threshold” counter is incremented by 1 at stage 404. Otherwise, the above-threshold counter is set to zero at stage 405 and the process reverts to stage 403, where the pulse width is increased by 1 unit, e.g. by an amount equal to the original pulse duration.

At stage 406, the controller determines whether the above-threshold counter is greater than or equal to 5, or other suitable number. If the above-threshold counter is greater than or equal to 5, then at stage 407 the Fill Counter is set equal to Fill Counter—4 (to account for the fact that the process 400 extended beyond the end of fill by 4 loops to ensure stability, e.g., 5 consecutive positive results) and the process 400 issues a Calibration complete flag. This is one implementation of a method to determine if a detected end of fill is considered a successful calibration, but it will be appreciated that other methods or variations of this method may instead be used classify a calibration as successful or completed.

Otherwise, the controller increments the Fill Counter by one and continues to stage 408, wherein the controller determines whether the transmission output speed exceeds a preset value such as 50 rpm. If it is determined that the transmission output speed does exceed, in this example, 50 rpm, then at stage 409 the process 400 sets a Calibration terminated early flag and terminates.

Otherwise, the process 400 continues to stage 410, wherein the controller determines whether the Fill Counter exceeds a preset upper fill time limit such as 30, corresponding to about 0.3 second for a typical controller loop time. If the Fill Counter is determined to exceed the preset upper fill time limit, then at stage 411 the process 400 issues a Calibration Failed flag and exits. In this case, it may be determined that the clutch itself is defective, e.g., due to a leak or other failure. Otherwise, the process 400 continues by returning to stage 403.

As can be seen, the process 400 eventually terminates either by rendering a final calibrated Fill Time (final pulse length), or by indicating a premature termination due to a change in conditions, or failure if warranted. This example presents one way to determine fill time, but as mentioned above, there are at least two other methods that may be used instead or in addition.

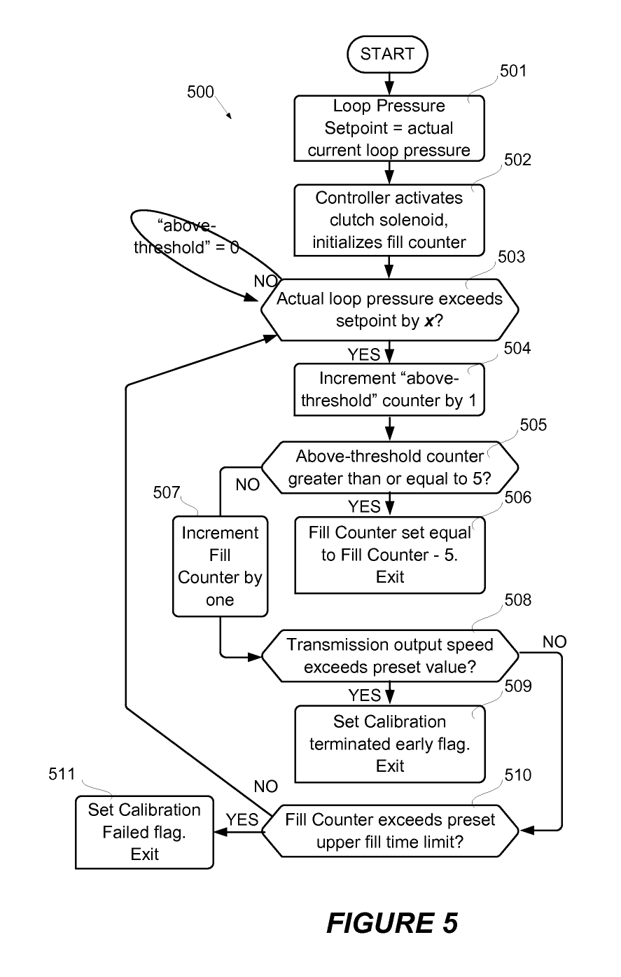

Referring to FIG. 5, a calibration process 500 is shown in accordance with another implementation, wherein the end of fill is detected based on detecting a predetermined level of loop pressure increase within the variator. The process 500 begins at stage 501, wherein a loop pressure setpoint is set equal to the actual current loop pressure (the difference between the pressures on opposite sides of the circuit, e.g., into motor and out of motor), smoothed or averaged, e.g., over 20 loops. (Although this example uses actual loop pressure, it will be appreciated that derivative values and or ratios of pressures or derivative values may be used in an alternative embodiment).

At stage 502, the controller turns on the clutch, i.e., it activates the clutch solenoid for filling for an initial pulse width and sets a Fill Counter to zero. At stage 503, the controller determines whether a measure of actual current loop pressure increase exceeds a loop pressure set point by more than a predetermined variance, e.g., a difference of some predetermined magnitude, or an increase in a ratio of current loop pressure vs. past loop pressure as noted above. If the loop pressure setpoint is exceeded by more than the predetermined variance, then at stage 504 the controller increments the “above-threshold counter by one. Otherwise, the above-threshold counter is set to zero.

At stage 505, the controller determines whether the above-threshold counter exceeds a predetermined number, e.g., five. If the above-threshold counter exceeds the predetermined number, then at stage 506 the controller decrements the Fill Counter by 4 and exits the calibration routine, optionally setting a Calibration complete flag. Otherwise, the controller increments the fill counter by 1 at stage 507.

At stage 508, the controller determines whether the transmission output speed is greater than a preset threshold tolerance, e.g., 50 rpm. If it is determined that the transmission output speed is greater than the preset threshold tolerance, then the controller exits the calibration process 500 at stage 509, optionally setting a Calibration terminated early flag. Otherwise, the process 500 continues to stage 510, wherein the controller determines whether the Fill Counter exceeds a predetermined upper limit, e.g., 30 loops, again corresponding to a fill time of about 0.3 second given a typical controller loop time. If it is determined that the Fill Counter exceeds the predetermined upper limit, then the process 500 exits at stage 511, with the controller optionally setting flag for Calibration Failure and/or Clutch Failure. Otherwise, the process 500 continues by returning to stage 503.

As will be appreciated, once the process 500 terminates other than by failure or premature loss of calibration conditions, the resulting pulse width represents the calibrated fill time for the clutch under test.

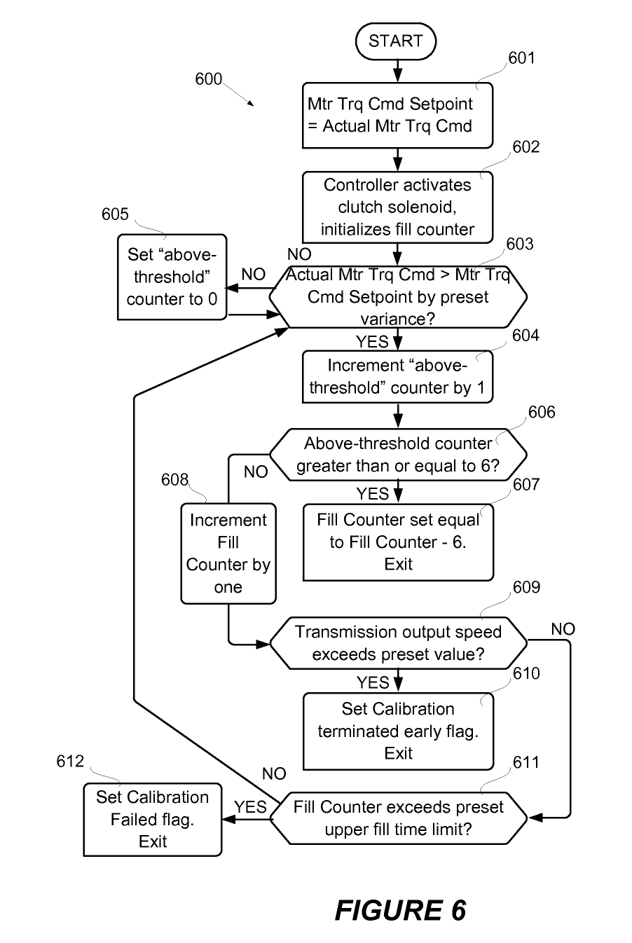

Yet another calibration methodology is discussed below. Referring to FIG. 6, a calibration process 600 is shown in accordance with another possible implementation, wherein the end of fill time is detected based on detecting a PID torque command variance of a certain extent. The process 600 begins at stage 601, wherein the controller sets a motor torque command setpoint (Mtr Trq Cmd Setpoint) equal to the actual current motor torque command (Actual Mtr Trq Cmd), smoothed or averaged, e.g., over 20 loops.

At stage 602, the controller activates the clutch solenoid of the relevant clutch to begin filling for an initial pulse width and sets a Fill Counter to zero. At stage 603, the controller determines whether Actual Mtr Trq Cmd exceeds the Mtr Trq Cmd Setpoint by at least a preset variance, wherein the preset variance is a predetermined torque such as 500 in-lb. If the Actual Mtr Trq Cmd exceeds the Mtr Trq Cmd Setpoint by at least the preset variance then the controller increments an above-threshold counter by one at stage 604. Otherwise, the above-threshold counter is reset to zero at stage 605.

At stage 606, the controller determines whether the above-threshold counter is greater than some predetermined value, e.g., 5, to ensure stability of any positive results. If yes, the controller sets the Fill Counter to the Fill Counter value minus four and exits calibration at stage 607, optionally setting a Calibration complete flag. Otherwise, the controller increments the Fill Counter, e.g., pulse width, by one at stage 608 and continues to stage 609.

At stage 609, the controller checks whether the transmission output speed exceeds some allowable limit, e.g., 50 rpm. If it is found that the transmission output speed does exceed the allowable limit, the process 600 exits at stage 610, optionally setting a Calibration terminated early flag. Otherwise, the process 600 continues to stage 611, wherein the controller checks whether the Fill Counter exceeds a predetermined upper limit, e.g., 30 (about 0.3 seconds). If it is determined that the Fill Counter does exceeds the predetermined upper limit, the process exits at stage 612, optionally setting a Calibration Failure and/or Clutch Failure flag. Otherwise, the process 600 returns to stage 603.

Calibration may be periodically necessary or desirable, e.g., when the clutches have never been calibrated and when calibrated clutch tolerances or characteristics have been altered by major maintenance, wear, or parts replacement. Although the flow charts and related descriptions above describe sequential computational and operational steps executable by way of traditional computing techniques, those of skill in the art will appreciate that many of these steps may alternatively be implemented via other suitable procedures such as neural computational techniques, and may, where appropriate, be executed in a different order than described above.

Because hydraulic source pressure may be a function of engine speed, the calibrated fill time values may be modified in an embodiment as a function for current engine speed to account for increased or decreased actual flow. In a further embodiment, the calibration process may be repeated at various engine speeds for each clutch of interest to account for the dependence of source pressure on engine speed. In this embodiment, extrapolation and/or interpolation may be used to calculate fill times for situations wherein actual engine RPM differs from the RPM at which the nearest calibration was executed.

### INDUSTRIAL APPLICABILITY

The industrial applicability of the clutch calibration system described herein will be readily appreciated from the foregoing discussion. A technique is described wherein the oncoming clutch fill time (pulse width) is calibrated to provide better shifts. Optimal shifting of continuously variable transmissions can thus be realized automatically, effectively, and without service interruption.

The present disclosure is applicable to continuously variable transmissions, including those having hydraulic clutches (sometimes referred to as “hydraulic transmissions”) or otherwise, such as may be used in heavy duty vocational machines. For example, heavy industrial machines, construction day cab trucks, refuse collection trucks, dump trucks, mixers, heavy haul tractors and so on may benefit from application of the teachings herein. In such machines, application of the foregoing teachings can provide improved user experience through smoother shifting as well as improved drive train longevity through lower frictional wear and impulse stresses.

The described system allows the operator of such a machine to calibrate the machine in the field without extensive down time for calibration. Thus, for example, a refuse truck that is newly manufactured or that has undergone major transmission work may nonetheless be immediately placed into service without prior calibration since the user can easily calibrate the clutches. This will improve transmission longevity and operator experience.

It will be appreciated that the foregoing description provides examples of the disclosed system and technique. However, it is contemplated that other implementations of the disclosure may differ in detail from the foregoing examples. All references to the invention or examples thereof are intended to reference the particular example being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A method of calibrating a continuously variable transmission for a machine, the transmission being driven by an engine and a secondary power source, and having first and second input shafts and an output shaft and including a plurality of clutches, each clutch operable to select one of the plurality of selectable gear ratios of the transmission when actuated, the method comprising:
receiving a request to calibrate one or more of the transmission clutches;
in response to receipt of the request to calibrate one or more of the transmission clutches, preparing the transmission for clutch calibration by:
commanding a set variable member speed;
applying a torque limit to the speed control; and
assuring engagement of a parking brake associated with the machine; and
executing a calibration routine for each clutch to identify a fill time for the clutch, the calibration routine comprising applying successively longer duration fill pulses to the clutch until clutch fill is detected.

2. The method of calibrating a continuously variable transmission for a machine according to claim 1, wherein the step of assuring engagement of a parking brake associated with the machine further includes one of actuating the parking brake and receiving a signal indicating successful user actuation of the parking brake.

3. The method of calibrating a continuously variable transmission for a machine according to claim 1, wherein the step of receiving a request to calibrate one or more of the transmission clutches comprises receiving a calibration request trigged by a user of the machine.

4. The method of calibrating a continuously variable transmission for a machine according to claim 1, wherein the step of applying a torque limit to the speed control comprises applying a torque limit to a proportional integral derivative control.

5. The method of calibrating a continuously variable transmission for a machine according to claim 1, further comprising determining that the calibration was successful and setting a calibration complete flag.

6. The method of calibrating a continuously variable transmission for a machine according to claim 1, further comprising determining that the calibration was not successful.

7. The method of calibrating a continuously variable transmission for a machine according to claim 6, wherein determining that the calibration was not successful comprises determining that calibration has not completed with application of a predetermined maximum pulse width.

8. The method of calibrating a continuously variable transmission for a machine according to claim 6, wherein determining that the calibration was not successful comprises detecting a transmission output speed during calibration above a preset RPM limit.

9. The method of calibrating a continuously variable transmission for a machine according to claim 1, wherein for each clutch the step of executing a calibration routine includes determining a clutch fill time at each one of a plurality of engine speeds.

10. The method of calibrating a continuously variable transmission for a machine according to claim 1, wherein the secondary power source is a variator.

11. A machine having a self-calibrating transmission system, the machine comprising:
an engine;
a continuously variable transmission having first and second inputs and an output, wherein the first input is linked to, and receives power from, the engine, the continuously variable transmission including a plurality of hydraulic clutches, each clutch operable to select one of the plurality of selectable ranges of the transmission when actuated;
a secondary power source linked to, and providing power to, the second input; and
a controller for calibrating the plurality of hydraulic clutches, the controller being configured to prepare the transmission for clutch calibration by commanding a set variable member speed, applying a torque limit to the speed control, and assure engagement of a parking brake associated with the machine, and to calibrate each clutch to identify a fill time for the clutch by applying successively longer duration fill pulses to the clutch until clutch fill is detected.

12. The machine having a self-calibrating transmission system according to claim 12, wherein the secondary power source is a hydraulic variator.

13. The machine having a self-calibrating transmission system according to claim 12, wherein assuring engagement of a parking brake associated with the machine further includes one of actuating the parking brake and receiving a signal indicating successful user actuation of the parking brake.

14. The machine having a self-calibrating transmission system according to claim 12, wherein applying a torque limit to the speed control comprises applying a torque limit to a proportional integral derivative control.

15. The machine having a self-calibrating transmission system according to claim 12, wherein the controller is further configured to determine that the calibration was not successful if calibration has not completed upon application of a pulse having a predetermined maximum pulse width.

16. The machine having a self-calibrating transmission system according to claim 12, wherein the controller is further configured to determine that the calibration was not successful if it detects a transmission output speed during calibration above a preset RPM limit.

17. The machine having a self-calibrating transmission system according to claim 12, wherein calibrating each clutch to identify a fill time for the clutch includes determining a clutch fill time for the clutch at each one of a plurality of engine speeds.

18. A method of calibrating a clutch shifted transmission having a plurality of clutches that, when actuated, cause a range change of the transmission, the transmission being associated with a machine that is propelled by the transmission, the method including:
activating a parking brake associated with the machine;
for each clutch calibrating the clutch by:
setting a transmission characteristic parameter to an initial value;
periodically activating a clutch solenoid associated with the clutch with successively longer fill pulses and measuring the transmission characteristic at each activation; and
when the measured value of the transmission characteristic exceeds the initial value for a predetermined number of consecutive periods, setting a fill pulse width for the clutch.

19. The method of calibrating a clutch shifted transmission according to claim 18, wherein setting the fill pulse width for the clutch when the measured value of the transmission characteristic exceeds the initial value for a predetermined number of consecutive periods comprises setting the pulse width to less than the final applied pulse width.

20. The method of calibrating a clutch shifted transmission according to claim 19, wherein setting the fill pulse width for the clutch when the measured value of the transmission characteristic exceeds the initial value for a predetermined number of consecutive periods comprises setting the pulse width to the pulse width applied when the measured value of the transmission characteristic first exceeded the initial value.
